(19) United States
(12) Patent Application Publication
(10) Pub. No.: US 2026/0013502 A1
(43) Pub. Date: Jan. 15, 2026

(54) METHOD FOR TERMINATING COVER CROP GROWTH

(71) Applicant: SUMITOMO CHEMICAL COMPANY, LIMITED, Tokyo (JP)

(72) Inventor: Yoshinao SADA, Takarazuka-shi (JP)

(73) Assignee: SUMITOMO CHEMICAL COMPANY, LIMITED, Tokyo (JP)

(21) Appl. No.: 18/836,612

(22) PCT Filed: Jan. 24, 2023
(86) PCT No.: PCT/JP2023/002017

§ 371 Date: Aug. 7, 2024

(30) Foreign Application Priority Data
Feb. 22, 2022 (JP) 2022-025548

(51) Int. Cl. A01N 43/54; A01N 43/84; A01P 13/00

(52) U.S. Cl. CPC A01N 43/54; A01N 43/84; A01P 13/00

(57) ABSTRACT

Provided is an effective method for terminating the growth of cover crops. In this method, cover crops are applied with at least one compound selected from epyrifenacil, tiafenacil, and trifludimoxazin.

### TECHNICAL FIELD

The present invention relates to a method for terminating the growth of cover crops.

### BACKGROUND ART

There has hitherto been known, as the method for terminating the growth of cover crops, a method for applying with a herbicide (Non-Patent Document 1). Certain compounds are known as the herbicide (Patent Documents 1 to 3).

### PRIOR ART DOCUMENT

### Patent Document

Patent Document 1: U.S. Pat. No. 6,537,948
Patent Document 2: U.S. Pat. No. 8,754,008
Patent Document 3: U.S. Pat. No. 8,193,198

### Non-Patent Document

Non-Patent Document 1: Weed Technology, 31, p. 514-522

### SUMMARY OF THE INVENTION

### Problems to be Solved by Invention

The object of the present invention is to provide a method for terminating the growth of cover crops.

### Means to Solve Problems

The present inventor has found that the growth of cover crops can be effectively terminated by application with certain PPO inhibitors.

The present invention includes the following [1] to [3].
[1] A method for terminating the growth of cover crops, comprising a step of applying cover crops with at least one compound selected from epyrifenacil, tiafenacil, and trifludimoxazin.
[2] The method according to [1], wherein the cover crops are one or more cover crops selected from cereal rye, triticale, barley, oat, wheat, annual ryegrass, radish, turnip, brown mustard, Abyssinian mustard, oilseed rape, hairy vetch, common pea, and crimson clover.
[3] The method according to [1], which comprises applying with epyrifenacil.

### Effects of Invention

According to the present invention, it becomes possible to effectively terminate the growth of cover crop.

### MODE FOR CARRYING OUT THE INVENTION

The method for terminating the growth of cover crops of the present invention (hereinafter referred to as the present method) comprises a step of applying cover crops with at least one compound selected from epyrifenacil, tiafenacil, and trifludimoxazin (hereinafter referred to as the present compound).

Epyrifenacil is a compound mentioned in U.S. Pat. No. 6,537,948 and can be produced by a known method. Tiafenacil is a compound mentioned in U.S. Pat. No. 8,193,198 and can be produced by a known method. Trifludimoxazin is a compound mentioned in U.S. Pat. No. 8,754,008 and can be produced by a known method.

There have been known, as epyrifenacil, at least three crystalline polymorphisms with different crystal structures (WO 2018/178039 A). There have been known, as trifludimoxazin, at least three crystalline polymorphisms with different crystal structures (WO 2013/174693 A and WO 2013/174694 A). When the present compound is used as a crystal, it may be a single crystal selected from each of these crystal polymorphs, or a mixture (mixed crystal) of any two or more crystals in any weight ratio. When an aqueous liquid suspension concentrate, an oil-based suspension concentrate, a wettable powder, a water dispersible granule or the like is prepared using the crystal of the present compound, a volume median diameter of crystal particles is usually 0.1 to 10 μm, preferably 0.2 to 5 μm, more preferably 1 to 4 μm, and still more preferably 2 to 3 μm. Particularly preferred is an aqueous liquid suspension concentrate in which the volume median diameter of crystal particles is 2 to 3 μm. The particle size distribution of the crystal can also be expressed based on any percentage, in addition to median (50%), and the “still more preferable range” can be expressed as “40%-volume diameter of 2.5 μm to 60%-volume diameter of 2.5 μm” or the like. Since the crystal of the present compound having a specified crystal structure (including a mixed crystal in any ratio) has a specific density, it is substantially the same even if the volume median diameter is expressed by the weight median diameter, and it can also be expressed by any percentage.

In the present method, a formulation containing the present compound is usually used as the present compound. The formulation containing the present compound is a formulation prepared by mixing the present compound with a carrier such as a solid carrier and a liquid carrier, and adding adjuvants for formulation such as surfactant as necessary. The form of the formulation is preferably an aqueous liquid suspension concentrate, an oil-based suspension concentrate, a wettable powder, a water dispersible granule, a water-based emulsion, an oil-based emulsion or an emulsifiable concentrate, and more preferably an emulsifiable concentrate or an aqueous liquid suspension concentrate.

The cover crops in the present method are usually seeded at the agricultural field before or after harvesting of summer crops (usually between 14 days before and 28 days after harvesting of summer crops, preferably between 7 days before and 14 days after harvesting of summer crops) and then allowed to grow over the winter. One of the significances of cultivating cover crops is that they cover the ground surface, which has the effect of suppressing weeds that grow at the same time as the cover crops or after termination of the growth, preventing soil erosion from the surface layer, preventing rainfall from running off to the surface layer, and increasing biodiversity in the agricultural ecosystem. Another significance is the development of the root system, which has the effect of absorbing fertilizer components not absorbed by summer crops and preventing leaching from the soil, improving the physical structure of the soil, introducing fertilizer components such as nitrogen into the soil, and introducing organic carbon (including, but not limited to, humic acid and fulvic acid) into the soil (carbon sequestration). In particular, the effect of carbon sequestration is emphasized from the viewpoint of climate change measures that is one of the sustainable development goals. Carbon sequestration is achieved primarily by the development of the root system, but is also achieved by the above-ground biomass becoming a component of the soil after termination of the growth.

In the present method, cover crops are usually subjected to foliar application with the present compound before or after the blooming period, after the cover crops have overwintered. The present compound applied quickly terminates the cover crop growth, and then the cover crops die and are not usually harvested or collected.

Termination of the cover crop growth in the present method refers to the cessation of further development of the cover crop buds (including terminal, lateral and adventitious buds, which may independently be floral or vegetative buds). Termination of the growth is recognized by the absence of new leaves spreading in the case of vegetative buds, and in the case of flower buds, it is recognized by the cessation of the processes of floral organ differentiation, flower bud setting, flowering, and fruiting. Termination of the growth is a phenomenon different from individual death, and in the present method, termination of the growth usually occurs before individual death.

The present method is an effective method for terminating the growth of cover crops. The significance of terminating the growth of cover crops includes improving the workability when reseeding summer crops before and after application with the herbicide (usually between 14 days before and 14 days after application with the herbicide, preferably between 7 days before and 7 days after application with the herbicide), promoting seedling establishment of summer crop by removing green shade, and removing competition for nutrient-moisture and light when the summer crop grows after seedling establishment. In particular, the significance of quick termination is that, even if cover crop biomass is maximized as much as possible due to carbon sequestration demands and then terminated, the optimal seeding time for the subsequent summer crops is not missed. An increase in cover crop biomass means an improvement in the above-said effects obtained by a cultivation of the cover crops. According to the present method, the growth of cover crops can be quickly terminated, thereby ensuring a longer growth period for the cover crops, leading to an increase in biomass. Depending on the herbicide to be used, the cover crops may lose its biomass during the period from application to termination of the growth as it releases the carbon it had fixed through respiration. However, according to the present method, the biomass does not decrease during the period from application to termination of the growth, and may even increase. There is usually no tillage from termination of the growth of cover crops until summer crops are seeded.

Examples of cover crops in the present method include, but are not limited to, gramineous cover crops such as cereal rye (Secale cereale), triticale (Triticale), barley (Hordeum vulgare), oat (Avena sativa), annual ryegrass (Lolium multiflorum), and wheat (Triticum aestivum); cruciferous cover crops such as radish (Raphanus sativus), turnip (Brassica rapa var. rapa), brown mustard (Brassica juncea), Abyssinian mustard (Brassica carinata), and oilseed rape (Brassica napus); and legume cover crops such as hairy vetch (Vicia villosa), common pea (Pisum sativum), and crimson clover (Trifolium incarnatum).

In the present method, the variety within each species of cover crops is not particularly limited. The cereal rye, triticale, barley, oat, and wheat are preferably autumn seeding varieties, but may be spring seeding varieties. The barley may be two-rowed barley (equal to beer barley), six-rowed barley, hulless barley or the like. The radish is preferably a variety group such as Tillage Radish, Oilseed Radish, Fodder Radish, Forage Radish, Groundhog Radish, and Nitro Radish, but edible Daikon Radish or common radish may also be used. The oilseed rape may be canola or non-canola variety and may be tolerant to certain herbicides.

The cover crop in the present method may be a single species seeded, or a mixture of multiple species seeded. Examples of mixed seeding include cereal rye+radish (Tillage Radish), barley+radish, cereal rye+radish+crimson clover, cereal rye+oilseed rape, oat+common pea, cereal rye+hairy vetch+crimson clover, cereal rye+common pea+hairy vetch+radish and the like.

The present method can control weeds that are growing together with cover crops or prevent weeds that will grow after application.

Examples of summer crops to be cultivated before and after the present method include soybean (indeterminate growth habit, determinate growth habit, semi-determinate growth habit), corn (dent corn, flint corn, flour corn, popcorn, waxy corn, sweet corn), sorghum, cotton (upland cotton, pima cotton), sugarcane, sunflower and the like.

Application of the present compound is usually performed by mixing a formulation containing the present compound with water to prepare a spray liquid and spraying the spray liquid. The spray volume is not particularly limited and is usually within a range of 50 to 1,000 L/ha, preferably 100 to 500 L/ha, and more preferably 140 to 300 L/ha.

The application rate of the present compound is usually 1 to 5,000 g per 10,000 m², preferably 2 to 2,000 g per 10,000 m², and more preferably 5 to 1,000 g per 10,000 m². Specifically, examples of the application rate include 5 g, 10 g, 12.5 g, 20 g, 25 g, 30 g, 40 g, 60 g, 80 g, and 100 g per 10,000 m².

In the present method, application may be performed after mixing the formulation containing the present compound with an adjuvant. The type of the adjuvant is not particularly limited, and examples thereof include oil-based adjuvants such as Agri-Dex and MSO, nonionic adjuvants (esters or ethers of polyoxyethylene) such as Induce, anionic adjuvants (substituted sulfonate) such as Gramin S, cationic adjuvants (polyoxyethylene amine) such as Genamin T 200BM, organosilicon-based adjuvants such as Silwet L77, ammonium sulfate, and urea+ammonium nitrate.

The pH and hardness of the spray liquid prepared when applied with the present compound are not particularly limited, and the pH is usually within a range of 5 to 9 and the hardness is usually within a range of 0 to 500.

The period of time for performing the present method is not particularly limited, and the period of time is usually within a range of 5 a.m. to 9 p.m. and the photon flux density in the place where application is performed is usually 10 to 2, 500 μmol/m²/second.

The spraying pressure to be employed for the application of the present compound is not particularly limited, and is usually 30 to 120 PSI, and desirably 40 to 80 PSI.

The type of the nozzle to be used for application with the present compound in the present method may be a flat fan nozzle or a drift-reducing nozzle. Examples of the flat fan nozzle include products of Teejet 110 series and XR Teejet 110 series manufactured by Teejet. The volume median diameter of liquid droplets ejected through each of the nozzles when using these nozzles at an ordinary spraying pressure, usually 30 to 120 PSI, is usually less than 430 microns. A drift-reducing nozzle is a nozzle reduced in drift compared with a flat fan nozzle and is called as “air induction nozzle” or “pre-orifice nozzle”. The volume median diameter of liquid droplets ejected through the drift-reducing nozzle is usually 430 microns or more.

An air induction nozzle has an air guide part between an inlet (spray liquid introduction part) of the nozzle and an outlet (spray liquid ejection part) of the nozzle, so that liquid droplets filled with air can be formed upon the mixing the spray liquid with air. Examples of the air induction nozzle include: TDXL11003-D, TDXL11004-D1, TDXL11005-D1 and TDXL11006-D manufactured by Green Leaf Technology; TTI110025, TTI11003, TTI11004, TTI11005, TTI11006 and TTI11008 manufactured by Teejet; and ULD120-041, ULD120-051 and ULD120-061 manufactured by Pentair. A particularly desirable one is TTI11004.

A pre-orifice nozzle is a nozzle in which an inlet (a spray liquid introduction part) of the nozzle serves as a metering orifice, so that large liquid droplets can be formed by controlling the flow amount to be flown into the nozzle so as to decrease the pressure in the nozzle. When the pre-orifice nozzle is used, the pressure during the ejection of the spray liquid can be reduced by half compared with the pressure before the introduction of the spray liquid. Examples of the pre-orifice nozzle include: DR110-10, UR110-05, UR110-06, UR110-08 and UR110-10 manufactured by Wilger; and 1/4TTJ08 Turf Jet and 1/4TTJ04 Turf Jet manufactured by Teejet.

The sprayer used in the present method may be a hooded sprayer certified by the U.S. Environmental Protection Agency (EPA) as drift reduction techlogy (DRT). Examples of the hooded sprayer with DRT certification include REDBALL 642, REDBALL 642E, REDBALL SPK645, REDBALL 645, REDBALL 645T, REDBALL SP645, REDBALL ATV642, and the like of Willmar Fabrication LLC.

The timing for applying cover crops with the present compound includes the vegetative stage, internode elongation stage, heading stage, flowering stage, and ripening stage for gramineous cover crops; the rosette stage, bolting stage, flowering stage, and ripening stage for cruciferous cover crops; and the vegetative stage, flower bud setting stage, flowering stage, and ripening stage for legume cover crops. In either case, it is preferable to do so before the flowering period. In the present method, the application with the present compound is usually performed once, but may be performed multiple times.

Specific examples of the weeds which can be simultaneously controlled by the present method include the following weeds, but are not limited thereto.
Urticaceae weeds: small nettle (Urtica urens)
Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), common sorrel (Rumex acetosa)
Portulacaceae weeds: common purslane (Portulaca oleracea)
Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), five-wound catchfly (Silene gallica)
Molluginaceae weeds: carpetweed (Mollugo verticillata)
Chenopodiaceae weeds: common lambsquarters (Chenopodium album), Indian goosefoot (Chenopodium ambrosioides), kochia (Bassia scoparia), spiny saltwort (Salsola kali), Orach (Atriplex spp.)
Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), perrotleaf (Alternanthera tenella)
Papaveraceae weeds: common poppy (Papaver rhoeas), field poppy (Papaver dubium), Mexican prickle poppy (Argemone mexicana)
Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), slender wartcress (Coronopus didymus) Capparaceae weeds: African cabbage (Cleome affinis)
Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, common cowpea (Vigna sinensis)
Oxalidaceae weeds: creeping wood sorrel (Oxalis corniculata), European wood sorrel (Oxalis stricta), purple shamrock (Oxalis oxyptera)
Geraniaceae weeds: Carolina geranium (Geranium carolinense), common storksbill (Erodium cicutarium)
Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), castor bean (Ricinus communis)
Malvaceae weeds: velvetleaf (Abutilon theophrasti), arrow-leaf sida (Sida rhombifolia), heart-leaf sida (Sida cordifolia), prickly sida (Sida spinosa), Sida glaziovii, Sida santaremnensis, bladder weed (Hibiscus trionum), spurred anoda (Anoda cristata), spine-seeded false-mallow (Malvastrum coromandelianum)
Onagraceae weeds: Ludwigia epilobioides, long-fruited primrose willow (Ludwigia octovalvis), winged water primrose (Ludwigia decurrens), common evening-primrose (Oenothera biennis), cutleaf evening-primrose (Oenothera laciniata) Sterculiaceae weeds: Florida waltheria (Waltheria indica)
Violaceae weeds: field violet; Viola arvensis, wild violet; Viola tricolor
Cucurbitaceae weeds: bur cucumber (Sicyos angulatus), wild cucumber (Echinocystis lobata), bitter balsam apple (Momordica charantia)
Lythraceae weeds: Ammannia multiflora, eared redstem (Ammannia auriculata), scarlet toothcup (Ammannia coccinea), purple loosestrife (Lythrum salicaria), Indian toothcup (Rotala indica)
Elatinaceae weeds: three-stamen waterwort (Elatine triandra), California waterwort (Elatine californica)
Apiaceae weeds: Chinese celery (Oenanthe javanica), wild carrot (Daucus carota), carrot fern (Conium maculatum)
Araliaceae weeds: lawn pennywort (Hydrocotyle sibthorpioides), floating pennywort (Hydrocotyle ranunculoides)
Ceratophyllaceae weeds: common hornwort (Ceratophyllum demersum)
Cabombaceae weeds: Carolina fanwort (Cabomba caroliniana)
Haloragaceae weeds: Brazilian water milfoil (Myriophyllum aquaticum), whorled water milfoil (Myriophyllum verticillatum), water milfoils (Myriophyllum spicatum, Myriophyllum heterophyllum, etc.)
Sapindaceae weeds: heartseed (Cardiospermum halicacabum)
Primulaceae weeds: scarlet pimpernel (Anagallis arvensis)
Asclepiadaceae weeds: common milkweed (Asclepias syriaca), honeyvine milkweed (Ampelamus albidus)
Rubiaceae weeds: catchweed bedstraw (Galium aparine), Galium spurium var. echinospermon, broadleaf buttonweed (Spermacoce latifolia), Brazil calla lily (Richardia brasiliensis), broadleaf buttonweed (Borreria alata)
Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), small-flower morning glory (Jacquemontia tamnifolia)
Boraginaceae weeds: field forget-me-not (Myosotis arvensis)
Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), field-nettle betony (Stachys arvensis)
Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), apple of Peru (Nicandra physalodes)
Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), dopatrium (Dopatrium junceum), Gratiola japonica
Plantaginaceae weeds: Asiatic plantain (Plantago asiatica), narrow-leaved plantain (Plantago lanceolata), broadleaf plantain (Plantago major), marsh water starwort (Callitriche palustris)
Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis), marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), spreading sneezeweed (Centipeda minima)
Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channelled water plantain (Alisma canaliculatum), common water plantain (Alisma plantago-aquatica)
Limnocharitaceae weeds: Sawah flowering rush (Limnocharis flava)
Hydrocharitaceae weeds: American frogbit (Limnobium spongia), Florida elodea (Hydrilla verticillata), common water nymph (Najas guadalupensis)
Araceae weeds: Nile cabbage (Pistia stratiotes)
Lemnaceae weeds: three-nerved duckweed (Lemna aoukikusa, Lemna paucicostata, Lemna aequinoctialis), common duckmeat (Spirodela polyrhiza), Wolffia spp.
Potamogetonaceae weeds: roundleaf pondweed (Potamogeton distinctus), pondweeds (Potamogeton crispus, Potamogeton illinoensis, Stuckenia pectinata, etc.)
Liliaceae weeds: wild onion (Allium canadense), wild garlic (Allium vineale), Chinese garlic (Allium macrostemon)
Pontederiaceae weeds: common water hyacinth (Eichhornia crassipes), blue mud plantain (Heteranthera limosa), Monochoria korsakowii, heartshape false pickerelweed (Monochoria vaginalis)
Commelinaceae weeds: common dayflower (Commelina communis), tropical spiderwort (Commelina benghalensis), erect dayflower (Commelina erecta), Asian spiderwort (Murdannia keisak)
Poaceae weeds: common barnyardgrass (Echinochloa crus-galli), early barnyardgrass (Echinochloa oryzicola), barnyard grass (Echinochloa crus-galli var formosensis), late watergrass (Echinochloa oryzoides), jungle rice (Echinochloa colonum), Gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (grain sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus tectorum), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), Japanese lawngrass (Zoysia japonica)
Cyperaceae weeds: Asian flatsedge (Cyperus microiria), rice flatsedge (Cyperus iria), hedgehog cyperus (Cyperus compressus), small-flowered nutsedge (Cyperus difformis), lax-flat sedge (Cyperus flaccidus), Cyperus globosus, Cyperus nipponicus, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green kyllinga (Kyllinga brevifolia), grasslike fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, river bulrush (Bolboschoenus fluviatilis)
Equisetaceae weeds: field horsetail (Equisetum arvense), marsh horsetail (Equisetum palustre)
Salviniaceae weeds: floating fern (Salvinia natans)
Azollaceae weeds: Japanese mosquitofern (Azolla japonica), feathered mosquito fern (Azolla pinnata)
Marsileaceae weeds: clover fern (Marsilea quadrifolia)
Other: Filamentous algae (Pithophora, Cladophora), Bryophyta, Marchantiophyta, Anthocerotophyta, Cyanobacteria, Pteridophyta, sucker of perennial crop (pome fruits, stone fruits, berry fruits, nuts, citrus fruits, hops, grapes, etc.)

In the above weeds, intra-specific variations are not particularly limited. Namely, the weeds also include any weeds that have reduced sensitivity (also referred to “have resistance”) to a specific herbicide. The reduced sensitivity may be attributed to a mutation at a target site (target site mutation), or may be attributed to any factors other than target site mutation (non-target site mutation). Target site mutation include those in which the substitution of amino acid residue of a protein as a target site occurred due to mutation of an open reading frame corresponding to amino acid sequence of the protein, and those in which the protein as the target site is overexpressed due to mutation such as deletion of the suppressor sequence in the promoter region, amplification of the enhancer sequence, or increase in the number of copies of gene.

Examples of the factor reducing sensitivity due to non-target site mutation include metabolic enhancement, defective absorption, defective transition, extrusion and the like. Examples of the factor of the metabolic enhancement includes enhanced activity of metabolic enzymes such as cytochrome P450 monooxygenases, aryl acylamidases, esterases and glutathione S-transferase. The extrution includes the transportation to a vacuole by an ABC transporter.

Examples of herbicide-resistant weeds include followings.

### Resistance to Glyphosate:

Examples of the reduced sensitivity of weeds due to target site mutation include weeds in which the substitution of any one amino acid residue or multiple amino acid residues selected from the below-mentioned amino acid residues occurs in EPSPS gene. Thr102Ile, Pro106Ser, Pro106Ala, Pro106Leu and Pro106Thr. Particularly, those with both of Thr102Ile and Pro106Ser, those with both of Thr102Ile and Pro106Thr, and those with Thr102Il, Pro106Ser and Pro381Leu are mentioned. Glyphosate-resistant goosegrass (Eleusine indica), Italian ryegrass (Lolium multiflorum), rigid ryegrass (Lolium rigidum), perennial ryegrass (Lolium perenne), Bidens subalternans and the like each having the target-site mutation are mentioned. Similarly, examples of the resistance to glyphosate due to target site mutation include those in which the number of copies of EPSPS gene is increased (PNAS, 2018 115 (13) 3332-3337). Glyphosate-resistant palmer amaranth (Amaranthus palmeri), waterhemp (Amaranthus tuberculatus), kochia (Bassia scoparia) in which the number of copies of EPSPS gene is increased and the like are mentioned. Examples of the reduced sensitivity of weeds due to non-target site mutation involved in the ABC transporter include Glyphosate-resistant marestail (Conyza canadensis), Guernsey fleabane (Conyza sumatrensis), fleabane (Conyza bonariensis) and the like. Furthermore, jungle rice (Echinochloa colona) in which sensitivity to glyphosate is reduced by increasing expression of aldo-keto reductase is known as non-target site mutation (Plant Physiology 181, 1519-1534).

### Resistance to ALS-Inhibition-Type Herbicides:

Examples of the reduced sensitivity of weeds due to target site mutation include weeds each having a mutation capable of causing the substitution of one amino acid residue or multiple amino acid residues selected from the below-mentioned amino acid residues in ALS gene as a target site mutation. Ala122Thr, Ala122Val, Ala122Tyr, Pro197Ser, Pro197His, Pro197Thr, Pro197Arg, Pro197Leu, Pro197Gln, Pro197Ala, Pro197Ile, Ala205Val, Ala205Phe, Asp376Glu, Asp376Gln, Asp376Asn, Arg377His, Trp574Leu, Trp574Gly, Trp574Met, Ser653Thr, Ser653Asn, Ser635Ile, Gly654Glu and Gly645Asp. ALS inhibitor-resistant redroot amaranth (Amaranthus retroflexus), smooth pigweed (Amaranthus hybridus), palmer amaranth (Amaranthus palmeri), waterhemp (Amaranthus tuberculatus), kochia (Bassia scoparia) and the like each having the target site mutation are mentioned. Examples of the reduced sensitivity of weeds due to non-target site mutation include weeds each having such a non-target site mutation that CYP or GST is involved to make the weed resistant to an ALS inhibitor. There have been known, as examples of the weeds, rigid ryegrass (Lolium rigidum) in which CYP81A10 and CYP81A1v1 are overexpressed, early barnyardgrass (Echinochloa oryzicola) in which CYP81A12 and CYP81A21 are overexpressed, and blackgrass (Alopecurus myosuroides) in which GSTF1 and GSTU2 are overexpressed. Resistance to ACCase inhibitors:

Examples of the reduced sensitivity of weeds due to target site mutation include weeds each having a mutation capable of causing the substitution of one amino acid residue or multiple amino acid residues in ACCase gene. Ile1781Leu, Ile1781Val, Ile1781Thr, Trp1999Cys, Trp1999Leu, Ala2004Val, Trp2027Cys, Ile2041Asn, Ile2041Val, Asp2078Gly, Asp2078Glu, Cys2088Arg, Gly2096Ala. Examples of the reduced sensitivity of weeds due to non-target site mutation include weeds each of which becomes resistant to an ACCase inhibitor as the result of the involvement of CYP or GST. There have been known, as examples of the weeds, rigid ryegrass (Lolium rigidum) in which CYP81A10 and CYP81A1v1 are overexpressed, early barnyardgrass (Echinochloa oryzicola) in which CYP81A12 and CYP81A21 are overexpressed, and blackgrass (Alopecurus myosuroides) in which GSTF1 and GSTU2 are overexpressed. Resistance to PPO inhibitors:

Examples of the reduced sensitivity of weeds due to target site mutation include weeds each having a mutation capable of causing the substitution of one amino acid residue or multiple amino acid residues in PPO gene. These mutations are known as or predicted to become carfentrazone-ethyl-, fomesafen- and lactofen-resistance mutations. Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deficit, Ala210 deficit, Gly210Thr, Ala210Thr, G211 deficit, Gly114Glu, Ser149Ile, Gly399Ala (all of amino acid numbers are standardized by sequence of PPO2 of palmer amaranth (Amaranthus palmeri)). Usually, PPO genes in a weed includes PPO1 gene and PPO2 gene. The above-mentioned mutation may occur in either one or both of PPO1 gene and PPO2 gene. It is preferred that the mutation occurs in PPO2 gene. For example, Arg128Met means that a mutation occurs in an amino acid residue located at position-128. In PPO2 gene of common ragweed (Ambrosia artemisiifolia), the mutation corresponds to position-98 (Weed Science 60, 335-344) and is known as Arg98Leu, and this Arg98 is the same as Arg128 in the present specification. In PPO gene of weeds to be controlled by the present invention, Arg128Met and Arg128Gly are known in palmer amaranth (Amaranthus palmeri) (Pest Management Science 73, 1559-1563), Arg128Gly is known as PPO2 of waterhemp (Amaranthus tuberculatus) (Pest Management Science, 2019; 75:3235-3244), Arg128Ile and Arg128Lys are known as PPO2 of waterhemp (Amaranthus tuberculatus) (Pest Management Science, 2019; 75:3235-3244), Arg128His is known as Arg132His by PPO2 of rigid ryegrass (Lolium rigidum) (WSSA annual meeting, 2018), Gly114Glu, Ser149Ile, and Gly399Ala are known by PPO2 of palmer amaranth (Amaranthus palmeri) (Frontiers in Plant Science 10, Article 568, and Ala210Thr is known as Ala212Thr by PPO1 of goosegrass (Eleusine indica) (Pest Management Science, doi: 10.1002/ps.5703). However, the PPO inhibitor-resistant weed to be controlled is not limited to these weeds. Namely, not only palmer amaranth (Amaranthus palmeri) having a mutation of Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deficit, Ala210 deficit, Gly210Thr, Ala210Thr, G211 deficit, Gly114Glu, Ser149Ile or Gly399Ala in PPO1 or PPO2 but also, for example, waterhemp (Amaranthus tuberculatus) having the same mutation, common ragweed (Ambrosia artemisiifolia) having the same mutation and wild poinsettia (Euphorbia heterophylla) having the same mutation are mentioned. As an example of the reduced sensitivity of weeds due to non-target site mutation, waterhemp (Amaranthus tuberculatus) which becomes resistant to carfentrazone-ethyl is known as waterhemp (Amaranthus tuberculatus) and palmer amaranth (Amaranthus palmeri) which become resistant to a PPO inhibitor as the result of the involvement of CYP or GST (PLOS ONE, doi: 10.1371/journal.pone. 0215431).

### Resistance to Auxin-Type Herbicides:

Examples of the target site mutation include a mutation which causes Gly-Asn in a degron region in AUX/IAA gene. kochia (Bassia scoparia), palmer amaranth (Amaranthus palmeri) and waterhemp (Amaranthus tuberculatus) each having this mutation are mentioned. As the non-target site mutation, dicamba-resistant green amaranth (Amaranthus chlorostachys Wiil) and 2,4-D-resistant waterhemp (Amaranthus tuberculatus) to which the involvement of CYP is suggested are known, and the non-target site mutation in which GST is involved is also mentioned.

### Resistance to HPPD Inhibitors:

Examples of the reduced sensitivity of weeds due to non-target site mutation include waterhemp (Amaranthus tuberculatus), palmer amaranth (Amaranthus palmeri) and the like each of which becomes resistant to an HPPD inhibitor as the result of the involvement of CYP or GST. As examples thereof, palmer amaranth (Amaranthus palmeri) in which CYP72A219, CYP81B and CYP81E8 are overexpressed are known. Resistance to photosystem II inhibitors:

Examples of the reduced sensitivity of weeds due to target site mutation include weeds each having a mutation capable of causing the substitution of one amino acid residue or multiple amino acid residues selected from the below-mentioned amino acid residues in psbA gene. Val219Ile, Ser264Gly, Ser264Ala, Phe274Val. Photosystem II inhibitor-resistant palmer amaranth (Amaranthus palmeri) and waterhemp (Amaranthus tuberculatus) each having this target site mutation are mentioned. Examples of the reduced sensitivity of weeds due to non-target site mutation include palmer amaranth (Amaranthus palmeri), waterhemp (Amaranthus tuberculatus) and the like each of which becomes resistant to a photosystem II inhibitor as the result of the involvement of CYP, GST or AAA. As an example thereof, rigid ryegrass (Lolium rigidum) in which CYP71R4 are overexpressed is known. Resistance to glutamate synthase inhibitors:

Examples of the reduced sensitivity of weeds due to target site mutation include weeds each having a mutation capable of causing the amino acid substitution of Asp171Asn and Ser59Gly in a glutamate synthase gene. Glutamate synthase inhibitor-resistant palmer amaranth (Amaranthus palmeri), waterhemp (Amaranthus tuberculatus) and the like each having this target site mutation are mentioned. Examples of the reduced sensitivity of weeds due to non-target site mutation include palmer amaranth (Amaranthus palmeri), waterhemp (Amaranthus tuberculatus) and the like each of which becomes resistant to glufosinate as the result of the involvement of CYP or GST. As an example thereof, palmer amaranth (Amaranthus palmeri) in which CYP72A219, CYP81B and CYP81E8 are overexpressed is known.

Resistant weeds may be resistant weeds each having a “combination (stack)” of at least two groups selected from the above-mentioned groups (arbitrarily selected two groups, arbitrarily selected three groups, arbitrarily selected four groups, arbitrarily selected five groups, arbitrarily selected six groups, arbitrarily selected seven groups or arbitrarily selected eight groups). For example, waterhemp (Amaranthus tuberculatus) having resistance to all of a photosystem II inhibitor, a HPPD inhibitor, 2,4-D, a PPO inhibitor, an ALS inhibitor and glyphosate is known as examples of the stacked resistant weeds. The stack may be a combination of target site mutations or a combination of non-target site mutations, or a combination of a target site mutation and a non-target site mutation.

Examples of the herbicide which may be used in the present method, in addition to the present compound, include the following herbicides. These herbicides can also be used in combination with the formulation comprising only the present compound as an active ingredient.

Herbicides: glyphosate and a salt thereof (isopropylammonium salt, ammonium salt, potassium salt, guanidine salt, dimethylamine salt, monoethanolamine salt, choline salt, BAPMA (N,N-bis-(aminopropyl)methylamine) salt, 2, 4-D and a salt or an ester thereof (triethanolamine salt, ammonium salt, butotyl ester, 2-butoxypropyl ester, butyl ester, diethylammonium salt, dimethylammonium salt, diolamine salt, dodecylammonium salt, ethyl ester, 2-ethylhexyl ester, heptylammonium salt, isobutyl ester, isooctyl ester, isopropyl ester, isopropylammonium salt, lithium salt, meptyl ester, methyl ester, octyl ester, pentyl ester, propyl ester, sodium salt, tefuryl ester, tetradecylammonium salt, triethylammonium salt, tris(2-hydroxypropyl)ammonium salt, a trolamine salt, choline salt), 2, 4-DB and a salt or an ester thereof (dimethylammonium salt, isooctyl ester, choline salt), pyroxasulfone, dicamba and a salt or an ester thereof (diglycolamine salt, dimethylammonium salt, diolamine salt, isopropylammonium salt, methyl ester, auramine salt, potassium salt, sodium salt, trolamine salt, BAPMA (N, N-bis-(aminopropyl)methylamine) salt, choline salt, TBA (tetrabutylammonium) salt, TBP (tetrabutylphosphonium) salt, MCPA and a salt or an ester thereof (dimethylammonium salt, 2-ethylhexyl ester, isooctyl ester, sodium salt, choline salt), MCPB, mecoprop and a salt or an ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or an ester thereof (dimethylammonium salt, 2-ethylhexyl ester, isobutyl salt, potassium salt, choline salt), dichlorprop and a salt or an ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, quinclorac, quinmerac, bromoxynil, bromoxynil-octanoate, dichlobenil, methiozolin, ioxynil, ioxynil-octanoate, di-allate, butylate, tri-allate, phenmedipham, chlorpropham, desmedipham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, terbumeton, terbuthylazine, terbutryn, trietazine, isoxaben, diuron, linuron, metobromuron, metoxuron, monolinuron, siduron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, lenacil, oxaziclomefone, cinmethylin, benfuresate, cafenstrole, flufenacet, pyrithiobac, pyrithiobac-sodium, pyriminobac, pyriminobac-methyl, bispyribac, bispyribac-sodium, pyribenzoxim, pyrimisulfan, pyriftalid, triafamone, fentrazamide, dimethenamid, dimethenamid-P, ACN, dithiopyr, triclopyr and a salt or an ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, norflurazon, fluridone, flurochloridone, flurtamone, benzobicyclon, bicyclopyrone, mesotrione, sulcotrione, tefuryltrione, tembotrione, isoxachlortole, isoxaflutole, benzofenap, pyrasulfotole, pyrazolynate, pyrazoxyfen, topramezone, tolpyralate, lancotrione-sodium, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, fenoxasulfone, glufosinate, glufosinate-ammonium, glufosinate-P, glufosinate-P-sodium, bialafos, anilofos, bensulide, butamifos, paraquat, paraquat-dichloride, diquat, diquat-dibromide, halauxifen, halauxifen-methyl, florpyrauxifen, florpyrauxifen-benzyl, flumioxazin, flumiclorac-pentyl, fomesafen-sodium, lactofen, saflufenacil, acifluorfen-sodium, aclonifen, bifenox, chlomethoxyfen, chlornitrofen, ethoxyfen-ethyl, fluorodifen, fluoroglycofen-ethyl, fluoronitrofen, halosafen, nitrofen, nitrofluorfen, oxyfluorfen, cinidon-ethyl, profluazol, pyraclonil, oxadiargyl, oxadiazone, pentoxazone, fluazolate, pyraflufen-ethyl, benzfendizone, butafenacil, fluthiacet-methyl, thidiazimin, azafenidin, carfentrazone-ethyl, sulfentrazone, flufenpyr-ethyl, indolauxipyr-cyanomethyl, icafolin-methyl, bixlozone, cyclopyranil, fenquinotrione, cyclopyrimorate, rimisoxafen, and tetflupyrolimet.

The herbicide which can be used in combination with the present compound in the present method is particularly preferably glyphosate-potassium salt, glyphosate-dimethylamine salt, glyphosate-monoethanolamine salt, glufosinate-ammonium salt, glufosinate-P-ammonium, glyphosate-isopropylammonium salt, 2, 4-D coline salt, pyroxasulfone, dicamba diglycolamine salt, dicamba BAPMA salt, dicamba TBA salt, dicamba TBP salt, flumioxazin, flumiclorac-pentyl, clethodim, lactofen, S-metolachlor, metribuzin, flufenacet, acetochlor, mesotrione, isoxaflutole, chlorimuron-ethyl, thifensulfuron-methyl, cloransulam-methyl, or imazethapyr-ammonium salt.

Examples of combinations with the herbicide which can be used in combination with the present compound in the present method (hereinafter sometimes referred to as herbicide Z) include, but are not limited to, the following. The ratio of the herbicide Z to the present compound is usually within a range of 0.01 to 1,000 times by weight, and preferably 0.1 to 300 times by weight. Specifically, examples thereof include 0.1 times, 0.2 times, 0.3 times, 0.4 times, 0.5 times, 0.6 times, 0.7 times, 0.8 times, 0.9 times, equivalent amount, 1.2 times, 1.5 times, 1.7 times, 2 times, 2.5 times, 3 times, 4 times, 5 times, 7 times, 10 times, 15 times, 20 times, 30 times, 40 times, 50 times, 60 times, 70 times, 80 times, 100 times, 150 times, and 200 times.

As used herein, when the active ingredient of the herbicides is a salt (e.g., glyphosate-potassium salt, 2,4-D choline salt, dicamba BAPMA salt), its weight means an acid equivalent unless otherwise specified.

Examples of more preferable specific combination when using the present composition in combination with one or more herbicides Z include epyrifenacil (20)+glyphosate-potassium salt (1261), and epyrifenacil (20)+glyphosate-monoethanolamine salt (1261). The number in parentheses is a preferable application rate (g/ha).

Examples of more preferable specific combination when using the present composition in combination with one or more herbicides Z include epyrifenacil (20)+dicamba diglycolamine salt (560), epyrifenacil (20)+dicamba BAPMA salt (560), epyrifenacil (20)+dicamba TBA salt (560), and epyrifenacil (20)+dicamba TBP salt (560). The number in parentheses is a preferable application rate (g/ha).

Examples of more preferable specific combination when using the present composition in combination with one or more herbicides Z include epyrifenacil (20)+glyphosate-potassium salt (1261)+dicamba diglycolamine salt (560), epyrifenacil (20)+glyphosate-potassium salt (1261)+dicamba BAPMA salt (560), epyrifenacil (20)+glyphosate-potassium salt (1261)+dicamba TBA salt (560), and epyrifenacil (20)+glyphosate-potassium salt (1261)+dicamba TBP salt (560). The number in parentheses is a preferable application rate (g/ha).

Examples of more preferable specific combination when using the present composition in combination with one or more herbicides Z include epyrifenacil (20)+glyphosate-monoethanolamine salt (1261)+dicamba diglycolamine salt (560), epyrifenacil (20)+glyphosate-monoethanolamine salt (1261)+dicamba BAPMA salt (560), epyrifenacil (20)+glyphosate-monoethanolamine salt (1261)+dicamba TBA salt (560), and epyrifenacil (20)+glyphosate-monoethanolamine salt (1261)+dicamba TBP salt (560). The number in parentheses is a preferable application rate (g/ha).

Examples of more preferable specific combination when using the present composition in combination with one or more herbicides Z include epyrifenacil (20)+flummoxazin (89)+glyphosate-potassium salt (1261), and epyrifenacil (20)+flumioxazin (89)+glyphosate-monoethanolamine salt (1261). The number in parentheses is a preferable application rate (g/ha).

Examples of more preferable specific combination when using the present composition in combination with one or more herbicides Z include epyrifenacil (20)+flumioxazin (89)+dicamba diglycolamine salt (1261), epyrifenacil (20)+flumioxazin (89)+dicamba BAPMA salt (560), epyrifenacil (20)+flumioxazin (89)+dicamba TBA salt (560), and epyrifenacil (20)+flumioxazin (89)+dicamba TBP salt (560). The number in parentheses is a preferable application rate (g/ha).

Examples of more preferable specific combination when using the present composition in combination with one or more herbicides Z include epyrifenacil (20)+flumioxazin (89)+glyphosate-potassium salt (1261)+dicamba diglycolamine salt (560), epyrifenacil (20)+flumioxazin (89)+glyphosate-potassium salt (1261)+dicamba BAPMA salt (560), epyrifenacil (20)+flumioxazin (89)+glyphosate-potassium salt (1261)+dicamba TBA salt (560), and epyrifenacil (20)+flumioxazin (89)+glyphosate-potassium salt (1261)+dicamba TBP salt (560). The number in parentheses is a preferable application rate (g/ha).

Examples of more preferable specific combination when using the present composition in combination with one or more herbicides Z include epyrifenacil (20)+flummoxazin (89)+glyphosate-monoethanolamine salt (1261)+dicamba diglycolamine salt (560), epyrifenacil (20)+flumioxazin (89)+glyphosate-monoethanolamine salt (1261)+dicamba BAPMA salt (560), epyrifenacil (20)+flummoxazin (89)+glyphosate-monoethanolamine salt (1261)+dicamba TBA salt (560), and epyrifenacil (20)+flumioxazin (89)+glyphosate-monoethanolamine salt (1261)+dicamba TBP salt (560). The number in parentheses is a preferable application rate (g/ha).

Examples of more preferable specific combination when using the present composition in combination with one or more herbicides Z include epyrifenacil (20)+2, 4-D choline salt (1065), epyrifenacil (20)+2,4-D dimethylamine salt (1065), epyrifenacil (20)+2,4-D triethanolamine salt (1065), and epyrifenacil (20)+2,4-D 2-ethylhexyl (1065). The number in parentheses is a preferable application rate (g/ha).

Examples of more preferable specific combination when using the present composition in combination with one or more herbicides Z include epyrifenacil (20)+glyphosate-potassium salt (1261)+2, 4-D choline salt (1065), epyrifenacil (20)+glyphosate-potassium salt (1261)+2,4-D dimethylamine salt (1065), epyrifenacil (20)+glyphosate-potassium salt (1261)+2, 4-D triethanolamine salt (1065), and epyrifenacil (20)+glyphosate-potassium salt (1261)+2, 4-D 2-ethylhexyl (1065). The number in parentheses is a preferable application rate (g/ha).

Examples of more preferable specific combination when using the present composition in combination with one or more herbicides Z include epyrifenacil (20)+glyphosate-monoethanolamine salt (1261)+2, 4-D choline salt (1065), epyrifenacil (20)+glyphosate-monoethanolamine salt (1261)+2,4-D dimethylamine salt (1065), epyrifenacil (20)+glyphosate-monoethanolamine salt (1261)+2,4-D triethanolamine salt (1065), and epyrifenacil (20)+glyphosate-monoethanolamine salt (1261)+2,4-D 2-ethylhexyl (1065). The number in parentheses is a preferable application rate (g/ha).

Examples of more preferable specific combination when using the present composition in combination with one or more herbicides Z include epyrifenacil (20)+flumioxazin (89)+2,4-D choline salt (1065), epyrifenacil (20)+flumioxazin (89)+2,4-D dimethylamine salt (1065), and epyrifenacil (20)+flumioxazin (89)+2, 4-D 2-ethylhexyl (1065). The number in parentheses is a preferable application rate (g/ha).

Examples of more preferable specific combination when using the present composition in combination with one or more herbicides Z include epyrifenacil (20)+flumioxazin (89)+glyphosate-potassium salt (1261)+2,4-D choline salt (1065), epyrifenacil (20)+flumioxazin (89)+glyphosate-potassium salt (1261)+2,4-D dimethylamine salt (1065), and epyrifenacil (20)+flumioxazin (89)+glyphosate-potassium salt (1261)+2,4-D 2-ethylhexyl (1065). The number in parentheses is a preferable application rate (g/ha).

Examples of more preferable specific combination when using the present composition in combination with one or more herbicides Z include epyrifenacil (20)+flummoxazin (89)+glyphosate-monoethanolamine salt (1261)+2,4-D choline salt (1065), epyrifenacil (20)+flumioxazin (89)+glyphosate-monoethanolamine salt (1261)+2,4-D dimethylamine salt (1065), and epyrifenacil (20)+flumioxazin (89)+glyphosate-monoethanolamine salt (1261)+2,4-D 2-ethylhexyl (1065). The number in parentheses is a preferable application rate (g/ha).

It is known to use salts of glyphosate, salts or esters of 2,4-D, and salts of dicamba, which appear in these combinations, to terminate the growth of cover crops in the absence of the present compound. In particular, glyphosate-potassium salt is widely used. In these known methods, it usually takes about one to three weeks for terminating the growth of cover crops, but the addition of the present compound allows for more quick termination. Therefore, in the present method, it is possible to wait until the cover crop forms larger biomass.

The above combination may further be combined with a drift-reducing agent. Specific examples of the drift-reducing agent are Intact (registered trademark) (manufactured by Precision Laboratories, LLC) and a drift-reducing agent registered as a Drift Reduction Adjuvant on the website (https://www.xtendimaxapplicationrequirements.com/#/search).

### EXAMPLES

The present invention will be described below by way of Examples, but the present invention is not limited to these Examples.

### Example 1

At the heading stage of cereal rye (Secale cereale) seeded in the autumn and overwintered outdoors after corn cultivation, epyrifenacil emulsifiable concentrate (55 g/L) was diluted with water containing 0.5% (v/v) adjuvant MSO+1% (w/v) ammonium sulfate, and the cereal rye is subjected to foliar application using a boom sprayer at a spray volume of 189 L/ha to deliver 40 g/ha of epyrifenacil. On the day after application, the growth of the cereal rye completely terminates, and 4 days after application, death of the cereal rye is observed.

### Example 2

At the bolting stage of radish (Tillage Radish) seeded in the autumn and overwintered outdoors after soybean cultivation, epyrifenacil emulsifiable concentrate (55 g/L) was diluted with water containing 0.5% (v/v) adjuvant Agri-Dex+1% (w/v) ammonium sulfate, and the radish is subjected to foliar application using a boom sprayer at a spray volume of 150 L/ha to deliver 20 g/ha of epyrifenacil. On the day after application, the growth of the radish completely terminates, and 3 days after application, death of the radish is observed.

### Example 3

At the internode elongation stage of barley (Hordeum vulgare) seeded in the autumn and overwintered outdoors in a corn cultivation trace, epyrifenacil emulsifiable concentrate (55 g/L) was diluted with water containing 0.5% (v/v) adjuvant Agri-Dex+1% (w/v) ammonium sulfate, and the barley is subjected to foliar application using a boom sprayer at a spray volume of 250 L/ha to deliver 30 g/ha of epyrifenacil. On the day after application, the growth of the barley completely terminates, and 4 days after application, death of the barley is observed.

### Examples 4 to 6

The same procedure is performed as in Examples 1 to 3, except that RoundupPowerMax (660 g/L of glyphosate-potassium salt) is further added at 32 fluid ounces/acre (1, 543 g/ha as glyphosate-potassium salt).

### Example 7

A plastic pot was filled with soil, and cereal rye (Secale cereale) was seeded and grown in a greenhouse. Fifteen days after seeding, RoundupPowerMax was diluted with water, and then the cereal rye was subjected to foliar application from above using an automatic sprayer at a spray volume of 200 L/ha to achieve an application rate of 1,543 g/ha as glyphosate-potassium salt.

At the same time, the cereal rye was similarly seeded in another plastic pot and grown. Twenty-one days after seeding, epyrifenacil emulsifiable concentrate (55 g/L) or saflufenacil suspension (341 g/L) was diluted with water containing 1% (v/v) adjuvant Agri-Dex, and then the cereal rye was subjected to foliar application from above using an automatic sprayer at a spray volume of 200 L/ha to achieve an application rate of 25 g/ha.

After application with the herbicide, the cereal rye was grown in a greenhouse, and in case the growth was terminated, the above-ground parts were harvested at termination of the growth and the dry matter weight was measured. In this test, the growth was judged to be terminated when death of terminal and lateral buds was visually confirmed. The date at the beginning of the onset of effect, the growth termination date, and the dry matter weight at the time of growth termination are shown in Table 1. The onset of the effect was judged by visually observing the change in leaf color. Application with each herbicide was performed using three pots. The date at the beginning of the onset of effect and the growth termination date in the table were dates on which the onset of effect and growth termination were confirmed in all three pots, respectively. The dry matter weight was the average of the three pots.

Epyrifenacil terminated the growth of the cereal rye 3 days after application. Even though the period from seeding of the cereal rye to termination of the growth was the same, when applied with epyrifenacil, the biomass was greater as compared with the case when applied with glyphosate potassium since the application time was later. When applied with saflufenacil, observations were made up to 50 days after seeding, but failed to terminate the growth of the cereal rye.

TABLE 1

| | | Date at the | | Dry |
|---|---|---|---|---|
| | Application | beginning of | Growth | matter |
| | rate | the onset of | termination | weight |
| | g/ha | effect | date | kg/ha |
| Epyrifenacil | 25 | On the day | 24 Days | 1,118 |
| | | of application | after | |
| | | | seeding (3 | |
| | | | days after | |
| | | | application) | |
| Glyphosate- | 1,543 | 5 Days after | 24 Days | 595 |
| potassium | | application | after | |
| salt | | | seeding (9 | |
| | | | days after | |
| | | | application) | |
| Saflufenacil | 25 | On the day | Growth is | — |
| | | of application | not | |
| | | | terminated | |
| | | | (observed | |
| | | | until 50 | |
| | | | days after | |
| | | | seeding) | |

### Example 8

A plastic pot was filled with soil, and edible radish (Daikon Radish) was seeded and grown in a greenhouse. Fifteen days after seeding, RoundupPowerMax was diluted with water, and then the radish was subjected to foliar application from above using an automatic sprayer at a spray volume of 200 L/ha to achieve an application rate of 1,543 g/ha as glyphosate-potassium salt.

At the same time, the radish was similarly seeded in another plastic pot and grown. Twenty-one days after seeding, epyrifenacil emulsifiable concentrate (55 g/L) was diluted with water containing 1% (v/v) adjuvant Agri-Dex, and then the radish was subjected to foliar application from above using an automatic sprayer at a spray volume of 200 L/ha to achieve an application rate of 25 g/ha.

After application with the herbicide, the radish was grown in a greenhouse, and in case the growth was terminated, the entire plant was dug up at termination of the growth and the dry matter weight was measured. In this test, the growth was judged to be terminated when death of terminal and lateral buds was visually confirmed. The date at the beginning of the onset of effect, the growth termination date, and the dry matter weight at the time of growth termination are shown in Table 2. The onset of the effect was judged by visually observing the change in leaf color. Application with each herbicide was performed using three pots. The date at the beginning of the onset of effect and the growth termination date in the table were dates on which the onset of effect and growth termination were confirmed in all three pots, respectively. The dry matter weight was the average of the three pots.

Epyrifenacil terminated the growth of the radish 3 days after application. Even though the period from seeding of the cereal rye to termination of the growth was the same, when applied with epyrifenacil, the biomass was greater as compared with the case when applied with glyphosate potassium since the application time was later.

TABLE 2

| | | Date at the | | Dry |
|---|---|---|---|---|
| | Application | beginning of | Growth | matter |
| | rate | the onset of | termination | weight |
| | g/ha | effect | date | kg/ha |
| Epyrifenacil | 25 | On the day of | 24 Days after | 905 |
| | | application | seeding (3 | |
| | | | days after | |
| | | | application) | |
| Glyphosate- | 1,543 | 7 Days after | 24 Days after | 360 |
| potassium | | application | seeding (9 | |
| salt | | | days after | |
| | | | application) | |

### Example 9

A plastic pot was filled with soil, and cereal rye (Secale cereale) was seeded and grown outdoors. Twenty-four days after seeding, RoundupPowerMax was diluted with water, and then the cereal rye was subjected to foliar application from above using an automatic sprayer at a spray volume of 200 L/ha to achieve an application rate of 1,543 g/ha as glyphosate-potassium salt.

At the same time, the cereal rye was similarly seeded in another plastic pot and grown. Twenty-four days after seeding, epyrifenacil emulsifiable concentrate (55 g/L) or saflufenacil suspension (341 g/L) was diluted with water containing 1% (v/v) adjuvant Agri-Dex, and then the cereal rye was subjected to foliar application from above using an automatic sprayer at a spray volume of 200 L/ha to achieve an application rate of 20 g/ha.

At the same time, the cereal rye was similarly seeded in another plastic pot and grown. Twenty-four days after seeding, the above-ground parts were harvested and the dry matter weight (hereinafter referred to as untreated dry matter weight) was measured.

The cereal rye applied with the herbicide was grown outdoors after application with the herbicide, and in case the growth was terminated, the above-ground parts were harvested at termination of the growth and the dry matter weight was measured. In this test, the growth was judged to be terminated when death of terminal and lateral buds was visually confirmed. The date at the beginning of the onset of effect, the growth termination date, and the dry matter weight at the time of growth termination are shown in Table 3. The onset of the effect was judged by visually observing the change in leaf color. Application with each herbicide was performed using seven pots. The date at the beginning of the onset of effect and the growth termination date in the table were dates on which the onset of effect and growth termination were confirmed in all seven pots, respectively. The incremental dry matter weight was the value calculated by the following formula (1).

Incremental dry matter weight=average dry matter weight at the time of growth termination−average untreated dry matter weight 24 days after seeding Formula (1):
Average dry matter weight at the time of growth termination: average value of dry matter weights of 7 pots at the time of growth termination
Average untreated dry matter weight 24 days after seeding: average value of untreated dry matter weights of 7 pots

Epyrifenacil terminated the growth of the cereal rye 7 days after application while increasing biomass. Meanwhile, glyphosate-potassium salt terminated the growth of the cereal rye 21 days after application and reduced biomass. The application with saflufenacil was observed up to 21 days after seeding, but failed to terminate the growth of the cereal rye.

TABLE 3

| | | Date at the | | Incremental |
|---|---|---|---|---|
| | Application | beginning of | Growth | dry matter |
| | rate | the onset of | termination | weight |
| | g/ha | effect | date | Kg/ha |
| Epyrifenacil | 20 | Day after | 7 Days | +127 |
| | | application | after | |
| | | | application | |
| Glyphosate- | 1,543 | 7 Days after | 21 Days | −42 |
| potassium | | application | after | |
| salt | | | application | |
| Saflufenacil | 20 | Day after | Growth is | — |
| | | application | not | |
| | | | terminated | |
| | | | (observed | |
| | | | until 28 | |
| | | | days after | |
| | | | seeding) | |

### Example 10

A plastic pot was filled with soil, and edible radish (Daikon Radish) was seeded and grown outdoors. Twenty-four days after seeding, RoundupPowerMax was diluted with water, and then the radish was subjected to foliar application from above using an automatic sprayer at a spray volume of 200 L/ha to achieve an application rate of 1, 543 g/ha as glyphosate-potassium salt.

At the same time, the radish was similarly seeded in another plastic pot and grown. Twenty-four days after seeding, epyrifenacil emulsifiable concentrate (55 g/L) was diluted with water containing 18 (v/v) adjuvant Agri-Dex, and then the radish was subjected to foliar application from above using an automatic sprayer at a spray volume of 200 L/ha to achieve an application rate of 20 g/ha.

At the same time, the radish was similarly seeded in another plastic pot and grown. Twenty-four days after seeding, the entire plant was dug up and the dry matter weight (hereinafter referred to as untreated dry matter weight) was measured.

The radish applied with the herbicide was grown outdoors after application with the herbicide, and in case the growth was terminated, the entire plant was dug up at termination of the growth and the dry matter weight was measured. In this test, the growth was judged to be terminated when death of terminal and lateral buds was visually confirmed. The date at the beginning of the onset of effect, the growth termination date, and the dry matter weight at the time of growth termination are shown in Table 4. The onset of the effect was judged by visually observing the change in leaf color. Application with each herbicide was performed using seven pots. The date at the beginning of the onset of effect and the growth termination date in the table were dates on which the onset of effect and growth termination were confirmed in all seven pots, respectively. The incremental dry matter weight was the value calculated by the following formula (2).

Incremental dry matter weight=average dry matter weight at the time of growth termination−average untreated dry matter weight 24 days after seeding Formula (2):
Average dry matter weight at the time of growth termination: average value of dry matter weights of 7 pots at the time of growth termination
Average untreated dry matter weight 24 days after seeding: average value of untreated dry matter weights of 7 pots

Epyrifenacil terminated the growth of the radish 7 days after application while increasing biomass. Meanwhile, glyphosate-potassium salt was observed up to 28 days after application, but failed to terminate the growth of the radish.

TABLE 4

| | | Date at the | | Incremental |
|---|---|---|---|---|
| | Application | beginning of | Growth | dry matter |
| | rate | the onset of | termination | weight |
| | g/ha | effect | date | Kg/ha |
| Epyrifenacil | 20 | Day after | 7 Days after | +98 |
| | | application | application | |
| Glyphosate- | 1,543 | 10 Days | Growth is | — |
| potassium | | after | not | |
| salt | | application | terminated | |
| | | | (observed | |
| | | | until 28 | |
| | | | days after | |
| | | | seeding) | |

### INDUSTRIAL APPLICABILITY

According to the present invention, it is possible to effectively terminate the growth of cover crops.

1. A method for terminating the growth of cover crops, comprising a step of applying cover crops with at least one compound selected from epyrifenacil, tiafenacil, and trifludimoxazin.

2. The method according to claim 1, wherein the cover crops are one or more cover crops selected from cereal rye, triticale, barley, oat, wheat, annual ryegrass, radish, turnip, brown mustard, Abyssinian mustard, oilseed rape, hairy vetch, common pea, and crimson clover.

3. The method according to claim 1, which comprises applying with epyrifenacil.
